(19) United States
(12) Patent Application Publication
(10) Pub. No.: US 2007/0186072 A1
(43) Pub. Date: Aug. 9, 2007

(54) Memory systems capable of reducing electromagnetic interference in data lines

(75) Inventor: Mi-Young Woo, Seongnam-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/655,194

(22) Filed: Jan. 19, 2007

(30) Foreign Application Priority Data
Feb. 4, 2006 (KR) 10-2006-0010915

(51) Int. Cl. G06F 13/00

(52) U.S. Cl. 711/167

(57) ABSTRACT

A memory system capable of reducing electromagnetic interference in data lines includes a memory controller and a synchronous semiconductor memory device. The memory controller controls the phases of write data strobe signals, which fetch write data transmitted through respective data lines. The synchronous semiconductor memory device receives the write data and controls the phases of read data strobe signals to be different from each other.

### PRIORITY STATEMENT

This non-provisional U.S. patent application claims priority under 35 U.S.C. §119 to Korean Patent Application No. 10-2006-0010915, filed on Feb. 4, 2006, in the Korean Intellectual Property Office (KIPO), the entire contents of which is incorporated herein by reference.

### BACKGROUND

### Description of the Related Art

A related art semiconductor memory device may be used as a main memory that inputs/outputs data to/from memory cells in a computer system. A data input/output rate of the semiconductor memory device may be important in determining the operating speed of the computer system.

A synchronous dynamic random access memory (SDRAM) includes an internal circuit that controls a memory operation in synchronization with a clock signal of a computer system. A related art SDRAM may include a single data rate (SDR) SDRAM and a double data rate (DDR) SDRAM. The SDR SDRAM may input or output one data per cycle of a clock signal in response to a rising edge or a falling edge of the clock signal. The DDR SDRAM may input or output two data per cycle of the clock signal in response to a rising edge and a falling edge of the clock signal. Accordingly, the bandwidth of the DDR SDRAM is twice the bandwidth of the SDR SDRAM.

A window of data input/output to/from the DDR SDRAM is smaller than a window of data input/output to/from the SDR SDRAM, and thus, a data strobe signal for fetching input/output data (or write/read data) may be required. Accordingly, the DDR SDRAM may include an extra pin for receiving the data strobe signal.

FIG. 1 is a block diagram of a related art memory system 10. Referring to FIG. 1, the memory system 10 may include a memory controller 12 and a synchronous semiconductor memory device 14 such as a DDR SDRAM.

The memory controller 12 controls data to be written to, or read from, the synchronous semiconductor memory device 14 through a plurality of data lines DL. The memory controller 12 is also referred to as a chipset.

The data transmitted through the data lines DL may be fetched by data strobe signals transmitted through data strobe lines DQSL1 and DQSL2. A clock signal transmitted through a clock line CKL may be used to synchronize the operation of the memory controller 12 with the operation of the synchronous semiconductor memory device 14. The data strobe signals transmitted through the data strobe lines DQSL1 and DQSL2 may be generated using the clock signal.

The related art memory system 10 transmits data through the data lines DL using the data strobe signals that are transferred through the data strobe lines DQSL1 and DQSL2. The data strobe signals may have the same phase. Thus, electromagnetic interference and/or simultaneous switching noise is generated in the data lines, and the data transmitted through the data lines DL may become distorted due to the electromagnetic interference and/or simultaneous switching noise.

### SUMMARY

Example embodiments relate to memory systems, for example, a memory system capable of reducing electromagnetic interference in data lines.

According to at least one example embodiment, a memory system may include a memory controller and a synchronous semiconductor memory device. The memory controller may control the phases of write data strobe signals to be different from each other, and may receive read data. The write data strobe signals may fetch write data transmitted through data lines. The synchronous semiconductor memory device may receive the write data and control phases of read data strobe signals, which respectively fetch read data transmitted through the data lines, to be different from each other.

According to at least one other example embodiment, a memory system may include a memory controller and a synchronous memory device. The memory controller may be configured to transmit write data through the data lines based on a first write data strobe signal and a second write data strobe signal. The first and second write data strobe signals may have different phases, and the memory controller may be further configured to receive read data. The synchronous memory device may be configured to receive the transmitted write data and transmit read data to the memory controller based on a first read data strobe signal and a second read data strobe signal. The first and second read data strobe signals may have different phases.

In at least some example embodiments, the memory controller may include a controller clock generator, a write delay unit and a data output buffer. The controller clock generator may synchronize an internal clock signal of the memory controller with a clock signal provided by the synchronous semiconductor memory device to generate a first write data strobe signal corresponding to one of the write data strobe signals. The write delay unit may delay the first write data strobe signal by a write delay time to generate a second write data strobe signal corresponding to one of the write data strobe signals. The data output buffer may buffer the write data in response to the first and second write data strobe signals and transmit the write data to the data lines. The memory controller may further include a write controller and a data strobe output buffer. The write controller may control the write delay unit to delay the first write data strobe signal by the write delay time, and the data strobe output buffer may buffer the first and second write data strobe signals and transmit the first and second write data strobe signals to first and second data strobe lines, respectively.

In at least some example embodiments, the synchronous semiconductor memory device may include a data strobe input buffer and a data input buffer. The data strobe input buffer may buffer the first and second write data strobe signals transmitted through the first and second data strobe lines, respectively, to generate first and second internal write data strobe signals. The data input buffer may buffer the write data transmitted through the data lines in response to the first and second internal write data strobe signals to generate internal write data. The synchronous semiconductor memory device may further include a memory clock generator, a read delay unit and a data output buffer. The memory clock generator may synchronize an internal clock signal of the synchronous semiconductor memory device with a clock signal provided by the memory controller to generate a first read data strobe signal corresponding to one of the read data strobe signals. The read delay unit may delay the first read data strobe signal by a read delay time to generate a second read data strobe signal corresponding to one of the read data strobe signals. The data output buffer may buffer the read data in response to the first and second read data strobe signals and transmit the read data to the data lines. The synchronous semiconductor memory device may further include a read controller and a data strobe output buffer. The read controller may control the read delay unit to delay the first read data strobe signal by the read delay time, and the data strobe output buffer may buffer the first and second read data strobe signals and transmit the first and second read data strobe signals to first and second data strobe lines, respectively. The memory controller may include a data strobe input buffer and a data input buffer. The data strobe input buffer may buffer the first and second read data strobe signals transmitted through the first and second data strobe lines, respectively, to generate first and second internal read data strobe signals, and the data input buffer may buffer the read data transmitted through the data lines in response to the first and second internal read data strobe signals to generate internal read data.

Memory systems, according to at least some example embodiments, may reduce electromagnetic interference and/or simultaneous switching noise generated in data lines by controlling data strobe signals, which fetch data transmitted through the data lines, to have different phases. This may suppress and/or prevent data from being distorted at higher or relatively high operating speeds.

### BRIEF DESCRIPTION OF THE DRAWINGS

Example embodiments will become more apparent by describing in detail the example embodiments shown in the attached drawings in which:

FIG. 1 is a block diagram of a related art memory system;

FIG. 2 is a block diagram of a memory system, according to an example embodiment;

FIG. 3 is a timing diagram illustrating an example write operation performed in the memory system of FIG. 2; and

FIG. 4 is a timing diagram illustrating an example read operation performed in the memory system of FIG. 2.

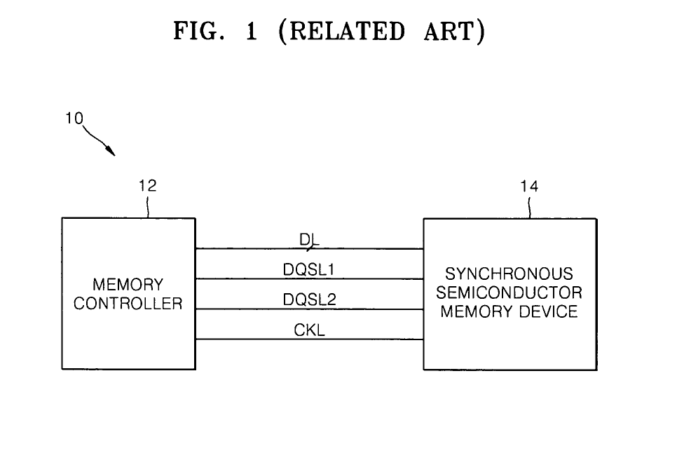

### DETAILED DESCRIPTION OF EXAMPLE EMBODIMENTS

Example embodiments will now be described more fully with reference to the accompanying drawings. Example embodiments may, however, be embodied in many different forms and should not be construed as being limited to the example embodiments set forth herein; rather, these example embodiments are provided so that this disclosure will be thorough and complete, and will fully convey the concept of the present invention to those skilled in the art. Throughout the drawings, like reference numerals refer to like elements.

Detailed illustrative embodiments of the present invention are disclosed herein. However, specific structural and functional details disclosed herein are merely representative for purposes of describing example embodiments of the present invention. This invention may, however, may be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

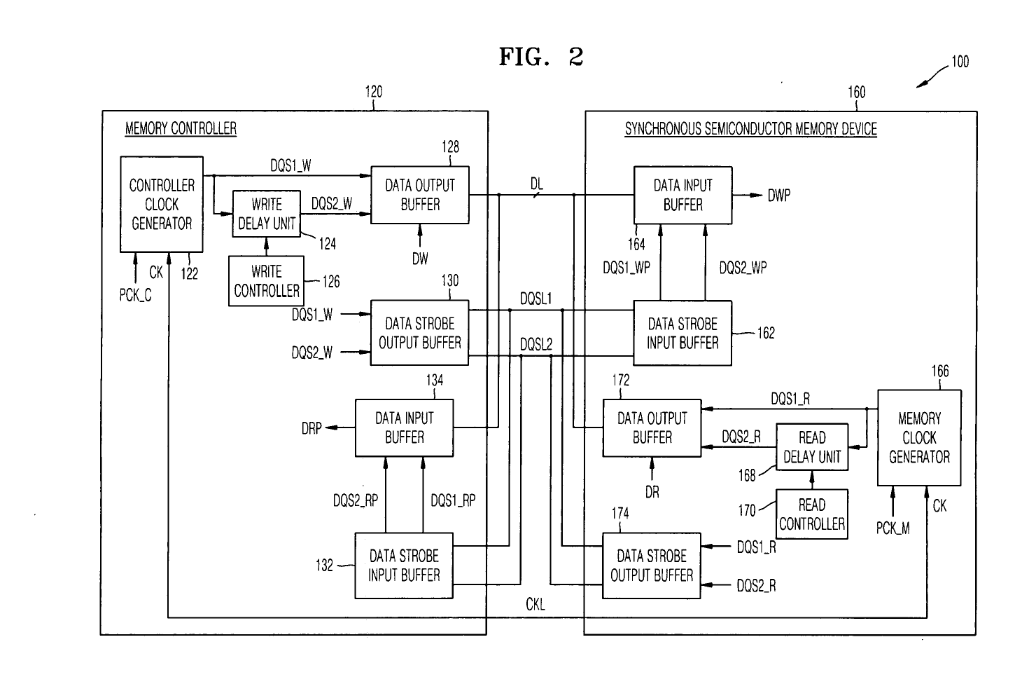

FIG. 2 is a block diagram of a memory system 100, according to an example embodiment. The memory system 100 may include a memory controller 120 and a synchronous semiconductor memory device 160. The memory controller may also be referred to as a chipset. The synchronous semiconductor memory device 160 may be, for example, a DDR SDRAM.

The memory controller 120 may control data to be written in the synchronous semiconductor memory device 160 through a plurality of data lines DL. The memory controller 120 may also control data to be read from the synchronous semiconductor memory device 160 through the data lines DL. The memory controller 120 may provide an address signal transmitted through an address line (not shown) and a command signal transmitted through a command line (not shown) to the synchronous semiconductor memory device 160 to control a write and/or a read operation of the synchronous semiconductor memory device 160.

The data transmitted through the data line DL may be fetched by data strobe signals transmitted through data strobe lines DQSL1 and DQSL2 to be transferred to the memory controller 120 or the synchronous semiconductor memory device 160. A clock signal CK transmitted through a clock line CKL may be used to synchronize the operation of the memory controller 120 with the operation of the synchronous semiconductor memory device 160. The data strobe signals transmitted through the data strobe lines DQSL1 and DQSL2 may be generated using the clock signal CK.

The memory controller 120 may include a controller clock generator 122, a write delay unit 124, a write controller 126, a data output buffer 128, a data strobe output buffer 130, a data strobe input buffer 132 and a data input buffer 134. The memory controller 120 may control first and second write data strobe signals DQS1_W and DQS2_W to have different phases, and may receive read data DR. The first and second write data strobe signals DQS1_W and DQS2_W may fetch write data DW transmitted through the data lines DL.

The synchronous semiconductor memory device 160 may include a data strobe input buffer 162, a data input buffer 164, a memory clock generator 166, a read delay unit 168, a read controller 170, a data output buffer 172 and/or a data strobe output buffer 174. The synchronous semiconductor memory device 160 may receive the write data DW and control first and second read data strobe signals DQS1_R and DQS2_R to have different phases. The first and second read data strobe signals DQS1_R and DQS2_R may fetch the read data DR transmitted through the data lines DL.

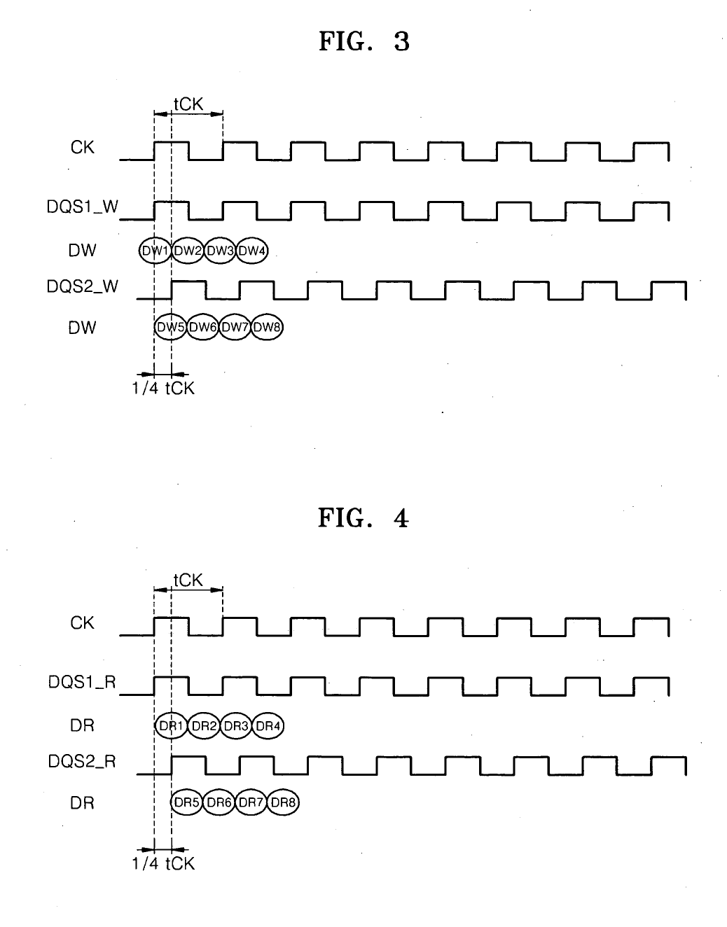

A write operation of the memory system 100, according to an example embodiment, will now be described with reference to FIGS. 2 and 3. FIG. 3 is a timing diagram illustrating the example write operation performed in the memory system 100 of FIG. 2.

The controller clock generator 122 may synchronize an internal clock signal PCK_C of the memory controller 120 with a clock signal CK provided by the memory clock generator 166 of the synchronous semiconductor memory device 160 to generate the first write data strobe signal DQS1_W. The controller clock generator 122 may include a phase locked loop circuit, a delay locked loop circuit or the like.

The write delay unit 124 may delay the first write data strobe signal DQS1_W by a write delay time to generate the second write data strobe signal DQS2_W. For example, the write delay unit 124 may delay the first write data strobe signals DQS1_W to generate a second write data strobe signal DQS2_W having a different phase relative to the first data strobe signal DQS1_W. The first and second write data strobe signals DQS1_W and DQS2_W may fetch the write data DW transmitted through the data lines DL.

The write delay unit 124 may include, for example, an inverter chain. The write delay time may be shorter than about half the period tCK of the clock signal CK. For example, the write delay time may correspond to about a quarter of the period tCK of the clock signal CK, as illustrated in FIG. 3.

The write controller 126 may control the write delay unit 124 to delay the first write data strobe signal DQS1_W by the write delay time.

The data output buffer 128 may buffer the write data DW in response to the first and second write data strobe signals DQS1_W and DQS2_W and transmit the write data DW to the data input buffer 164 via data lines DL. For example, four write data DW1, DW2, DW3 and DW4, fetched at respective rising edges and falling edges of the first write data strobe signal DQS1_W, may be transmitted (e.g., continuously) through at least one of data lines DL and four write data DW5, DW6, DW7 and DW8, fetched at respective rising edges and falling edges of the second write data strobe signal DQS2_W, may be transmitted (e.g., continuously) through at least one other data line DL, as illustrated in FIG. 3. In at least this example embodiment, a burst length of the write data DW transmitted through a single data line may be 4.

As described above, the memory system 100, according to example embodiments may reduce electromagnetic interference and/or simultaneous switching noise generated in the data lines by controlling the write data strobe signals to have different phases. This may also suppress (e.g., prevent) the write data from being distorted at higher operating speeds.

The data strobe output buffer 130 may buffer the first and second write data strobe signals DQS1_W and DQS2_W and transmit the first and second write data strobe signals DQS1_W and DQS2_W to the data strobe input buffer 162 via first and second data strobe lines DQSL1 and DQSL2, respectively.

The data strobe input buffer 162 of the synchronous semiconductor memory device 160 may buffer the first and second write data strobe signals DQS1_W and DQS2_W received via the first and second data strobe lines DQSL1 and DQSL2, respectively, to generate first and second internal write data strobe signals DQS1_WP and DQS2_WP.

The data input buffer 164 of the synchronous semiconductor memory device 160 may buffer the write data (e.g., DW1 through DW8) transmitted through the plurality of data lines DL (e.g., two data lines DL) in response to the first and second internal write data strobe signals DQS1_WP and DQS2_WP to generate internal write data DWP. The internal write data DWP may be written in memory cells (not shown) of the synchronous semiconductor memory device 160.

A read operation of the memory system 100, according to an example embodiment, will now be described with reference to FIGS. 2 and 4. FIG. 4 is a timing diagram illustrating an example read operation performed in the memory system 100 of FIG. 2.

The memory clock generator 166 may synchronize an internal clock signal PCK_M of the synchronous semiconductor memory device 160 with a clock signal CK provided by the controller clock generator 122 to generate the first read data strobe signal DQS1_R. The memory clock generator 166 may include a phase locked loop circuit, a delay locked loop circuit or the like.

The read delay unit 168 may delay the first read data strobe signal DQS1_R by a read delay time to generate the second read data strobe signal DQS2_R. For example, the read delay unit 168 may delay the first read data strobe signal DQS1_R to generate a second read data strobe signal DQS2_R having a different phase relative to the first read data strobe signal DQS1_R. The first and second read data strobe signals DQS1_R and DQS2_R may fetch the read data DR transmitted via data lines DL.

The read delay unit 168 may include, for example, an inverter chain. The read delay time may be shorter than about half the period tCK of the clock signal CK. In one example embodiment, the read delay time may correspond to a quarter of the period tCK of the clock signal CK, as illustrated in FIG. 4.

The read controller 170 may control the read delay unit 168 to delay the first read data strobe signal DQS1_R by the read delay time to generate the second read data strobe signal DQS2_R.

The data output buffer 172 may buffer the read data DR read from the memory cells of the synchronous semiconductor memory device 160 in response to the first and second read data strobe signals DQS1_R and DQS2_R and may transmit the read data DR to the data input buffer 134 via data lines DL. For example, four read data DR1, DR2, DR3 and DR4, fetched at respective rising edges and falling edges of the first read data strobe signal DQS1_R, may be transmitted (e.g., continuously) through at least one of data lines DL and four read data DR5, DR6, DR7 and DR8, fetched at respective rising edges and falling edges of the second read data strobe signal DQS2_R, may be transmitted (e.g., continuously) through at least one other of the data lines DL, as illustrated in FIG. 4. For example, a burst length of the read data DR transmitted through a single data line may be 4.

As described above, the memory system 100, according to at least one example embodiment, may reduce electromagnetic interference and/or simultaneous switching noise generated in data lines by controlling the read data strobe signals to have different phases. This may suppress (e.g., prevent) the read data from being distorted at higher operating speeds.

The data strobe output buffer 174 may buffer the first and second read data strobe signals DQS1_R and DQS2_R and transmit the first and second read data strobe signals DQS1_R and DQS2_R to the data strobe input buffer 132 via first and second data strobe lines DQSL1 and DQSL2, respectively.

The data strobe input buffer 132 of the memory controller 120 may buffer the first and second read data strobe signals DQS1_R and DQS2_R received via the first and second data strobe lines DQSL1 and DQSL2 to generate first and second internal read data strobe signals DQS1_RP and DQS2_RP, respectively.

The data input buffer 134 of the memory controller 120 may buffer the read data (e.g., DR1 through DR8) received via the plurality of data lines DL (e.g., two data lines DL) in response to the first and second internal read data strobe signals DQS1_RP and DQS2_RP to generate internal read data DRP. The internal read data DRP may be used in an internal circuit block of the memory controller 120 or input to a cache memory and/or a central processing unit which may be arranged external to the memory controller 120.

While example embodiments have been particularly shown and described with reference to the example embodiments shown in the figures, it will be understood by those of ordinary skill in the art that various changes in form and details may be made therein without departing from the spirit and scope of the present invention as defined by the following claims.

What is claimed is:

1. A memory system comprising:
a memory controller configured to control phases of a first and a second write data strobe signals to be different from each other, and configured to receive read data, the first and second write data strobe signals fetching write data transmitted through data lines; and
a synchronous memory device configured to receive the fetched write data, and configured to control phases of a first and a second read data strobe signal to be different from each other, the first and second read data strobe signals fetching read data transmitted through the data lines.

2. The memory system of claim 1, wherein the memory controller includes,
a controller clock generator configured to synchronize an internal clock signal of the memory controller with a clock signal provided by the synchronous memory device to generate the first write data strobe signal,
a write delay unit configured to delay the first write data strobe signal by a write delay time to generate the second write data strobe signal, and
a data output buffer configured to buffer the write data in response to the first and second write data strobe signals and transmit the write data.

3. The memory system of claim 2, wherein the memory controller further includes,
a write controller configured to control the write delay time of the write delay unit, and
a data strobe output buffer configured to buffer the first and second write data strobe signals and transmit the first and second write data strobe signals to the synchronous memory device via first and second data strobe lines, respectively.

4. The memory system of claim 3, wherein the synchronous semiconductor memory device includes,
a data strobe input buffer configured to buffer the first and second write data strobe signals received from the memory controller to generate first and second internal write data strobe signals, and
a data input buffer configured to buffer the write data received from the memory controller in response to the first and second internal write data strobe signals to generate internal write data.

5. The memory system of claim 2, wherein the write delay time corresponds to about a quarter of a period of the clock signal.

6. The memory system of claim 2, wherein the write delay unit includes, an inverter chain.

7. The memory system of claim 2, wherein the controller clock generator includes,
a phase locked loop circuit or a delay locked loop circuit.

8. The memory system of claim 1, wherein the synchronous memory device includes,
a memory clock generator configured to synchronize an internal clock signal of the synchronous memory device with a clock signal from the memory controller to generate the first read data strobe signal,
a read delay unit configured to delay the first read data strobe signal by a read delay time to generate the second read data strobe signal, and
a data output buffer configured to buffer the read data in response to the first and second read data -strobe signals and transmit the read data to the memory controller via the data lines.

9. The memory system of claim 8, wherein the synchronous semiconductor memory device further includes,
a read controller configured to control the read delay time of the read delay unit, and
a data strobe output buffer configured to buffer the first and second read data strobe signals and transmit the first and second read data strobe signals to the memory controller via first and second data strobe lines, respectively.

10. The memory system of claim 9, wherein the memory controller includes,
a data strobe input buffer configured to buffer the first and second read data strobe signals received via the first and second data strobe lines to generate first and second internal read data strobe signals, and
a data input buffer configured to buffer the read data received via the data lines in response to the first and second internal read data strobe signals to generate internal read data.

11. The memory system of claim 8, wherein the read delay unit includes,
an inverter chain.

12. The memory system of claim 8, wherein the memory clock generator includes,
a phase locked loop circuit or a delay locked loop circuit.

13. The memory system of claim 8, wherein the read delay time corresponds to about a quarter of a period of the clock signal.

14. A memory system comprising:
a memory controller configured to transmit write data through data lines based on a first write data strobe signal and a second write data strobe signal, the first and second write data strobe signals having different phases, and the memory controller being further configured to receive read data; and
a synchronous memory device configured to receive the transmitted write data and transmit read data to the memory controller based on a first read data strobe signal and a second read data strobe signal, the first and second read data strobe signals having different phases.

15. The memory system of claim 14, wherein the memory controller includes,
a controller clock generator configured to synchronize an internal clock signal of the memory controller with a clock signal provided by the synchronous memory device to generate the first write data strobe signal,
a write delay unit configured to delay the first write data strobe signal by a write delay time to generate the second write data strobe signal, and
a data output buffer configured to buffer the write data in response to the first and second write data strobe signals and transmit the write data.

16. The memory system of claim 15, wherein the memory controller further includes,
a write controller configured to control the write delay time of the write delay unit, and
a data strobe output buffer configured to buffer the first and second write data strobe signals and transmit the first and second write data strobe signals to the synchronous memory device via first and second data strobe lines, respectively.

17. The memory system of claim 16, wherein the synchronous semiconductor memory device includes,
a data strobe input buffer configured to buffer the first and second write data strobe signals received from the memory controller to generate first and second internal write data strobe signals, and
a data input buffer configured to buffer the write data received from the memory controller in response to the first and second internal write data strobe signals to generate internal write data.

18. The memory system of claim 14, wherein the synchronous memory device includes,
a memory clock generator configured to synchronize an internal clock signal of the synchronous memory device with a clock signal from the memory controller to generate the first read data strobe signal,
a read delay unit configured to delay the first read data strobe signal by a read delay time to generate the second read data strobe signal, and
a data output buffer configured to buffer the read data in response to the first and second read data strobe signals and transmit the read data to the memory controller via the data lines.

19. The memory system of claim 18, wherein the synchronous semiconductor memory device further includes,
a read controller configured to control the read delay time of the read delay unit, and
a data strobe output buffer configured to buffer the first and second read data strobe signals and transmit the first and second read data strobe signals to the memory controller via first and second data strobe lines, respectively.

20. The memory system of claim 19, wherein the memory controller includes,
a data strobe input buffer configured to buffer the first and second read data strobe signals received via the first and second data strobe lines to generate first and second internal read data strobe signals, and
a data input buffer configured to buffer the read data received via the data lines in response to the first and second internal read data strobe signals to generate internal read data.
